(19) United States
(12) Patent Application Publication
(10) Pub. No.: US 2022/0318856 A1
(43) Pub. Date: Oct. 6, 2022

(54) ADVERTISEMENT SYSTEM AND METHOD OF PRINTER

(71) Applicants: Hui HWANG, Ulsan (KR); MALGUEN CO., LTD, Ulsan (KR)

(72) Inventor: Hui HWANG, Ulsan (KR)

(21) Appl. No.: 17/616,180

(22) PCT Filed: Jan. 23, 2020
(86) PCT No.: PCT/KR2020/001204

§ 371 Date: Dec. 2, 2021

(30) Foreign Application Priority Data
Jun. 4, 2019 (KR) 10-2019-0065731

(51) Int. Cl. G06Q 30/02; G06F 3/12

(52) U.S. Cl. CPC G06Q 30/0276; G06F 3/1243; G06F 3/1259; G06F 3/1285; G06F 3/1203; G06Q 30/0272; G06Q 30/0273; G06Q 30/0271; G06Q 30/0257

(57) ABSTRACT

An advertisement system and method of a printer is proposed. Particularly, customized advertisement content is displayed on a computing device interworked with the printer during a print waiting time, or the customized advertisement content for each user is output on a printout of an output device. In the advertisement system of the printer, a user-customized advertisement is displayed during the print waiting time that inevitably occurs when outputting to the printer, or user-customized content is output according to a layout and design of the printout. In addition, the advertisement system of the printer provides a rental fee discount, point and reward accumulation of the printer according to an amount of time the advertisement is output from the output device and an advertising print volume, so that a user who rented the printer may generate revenue and an advertiser may improve advertising effectiveness through the advertisement system of the printer.

### CROSS-REFERENCE TO RELATED APPLICATION

This Application is a Section 371 National Stage Application of International Application No. PCT/KR2020/001204, filed Jan. 23, 2020, the contents of which is hereby incorporated by reference in its entirety.

### TECHNICAL FIELD

The present disclosure relates to an advertisement system and method of a printer and, more particularly, to an advertisement system and advertisement method of a printer, wherein customized advertisement content is displayed on a computing device interworked with an output device during a print waiting time, or customized advertisement content for each user is output on a printout of the output device.

### BACKGROUND

Unless otherwise indicated in the present disclosure, the content described in this section is not related art to the claims of this application and is not admitted to be the related art by inclusion in this section.

A printer is necessary office equipment that interworks with a computing device to output a message received from the computing device. Printers are provided in various office spaces and personal spaces, such as offices, schools, public institutions, and homes. In general, in order to use the printer, an output screen is set on the computing device interworked with the printer, and when an output request signal is transmitted to the printer after setting the number of prints, a size, design, and the like, the printer outputs a printout according to the received output request signal. After that, a user goes to the printer and collects the printout he or she has printed. When the printer processes the output request signal, there occurs an inevitable print waiting time. Conventionally, it is common to wait while checking the status of a printout until printing is completed in the vicinity of a printer during a print waiting time, which always occurs when using the printer, or it is common to wait while monitoring a user's computer during the print waiting time.

### SUMMARY

### Technical Problem

An objective of the present disclosure is to provide an advertisement system of a printer configured to display a user-customized advertisement on a computing device interworked with an output device, or output user-customized content to a printout according to a layout and design of the printout, during a print waiting time that inevitably occurs when using a printer. The advertisement system of the printer according to an exemplary embodiment of the present disclosure checks an amount of time during which the advertisement is output and an advertising print volume, on the computing device interworked with the output device, so as to provide a rental fee discount, point, and reward of a printer, thereby enabling a user who rented the printer to generate revenue and an advertiser to improve advertising effectiveness through the advertisement system of the printer.

### Technical Solution

According to an exemplary embodiment, an advertisement system of a printer includes: a central server configured to store detailed output device information including a type of an output device, an installation location, an advertisement output time, the number of times of advertisement output, and a rental fee, which are registered in the advertisement system of the printer, select an advertisement to be output to a user's computing device interworked with the output device by using the detailed output device information and registered user information, and control the advertisement output; the output device configured to expose the advertisement on a printout according to the control of the advertisement output of the central server; and the user's computing device configured to output the selected advertisement on a screen according to the control of the central server or the output device.

According to another exemplary embodiment, an advertisement method of an advertisement system of a printer includes: step (A) of storing and updating, in a central server, detailed output device information including a type of an output device, an installation location, an advertisement output time, the number of times of advertisement output, and a rental fee, information on a user subscribing to the system, and information on a customer using the output device; step (B) of receiving, in the output device, an output request signal from a computing device interworked with the output device; step (C) of selecting, in the output device, an advertisement to be output to the output device or a printout according to personal information of the user of the computing device transmitting the output request signal, output information, an area where the output device is installed, and a printing waiting time; step (D) of displaying the advertisement selected in a print waiting time of the printout to the computing device when the advertisement is displayed on the output device; step (E) of calculating a size and a layout of an advertisement image to be printed according to the number of pages, a size, a layout, and design of the printout when the advertisement is printed on the printout of the output device; and step (F) of outputting the advertisement image on printing paper according to the calculated size and layout of the advertisement image.

### Advantageous Effects

The advertisement system of the printer as described above calculates an advertisement fee and a reward by respectively displaying or outputting an advertisement with a computing device or a printout during a print waiting time that inevitably occurs when using a printer, thereby enabling both a rental company and a user who rented the printer to generate additional revenue, and enabling the rental company to increase the advertising effectiveness by exposing the advertisement during the print waiting time that inevitably occurs. In addition, when the calculated print waiting time is less than a predetermined time, advertisement content is allowed to be printed on the printout, so that the advertising effectiveness may be generated even with a short print waiting time.

The effects of the present disclosure are not limited to the above effects, and should be understood to include all effects that can be inferred from the detailed description of the present disclosure or the configuration of the present disclosure described in the claims.

### BRIEF DESCRIPTION OF THE DRAWINGS

FIG. 1 is a view illustrating a configuration of an advertisement system of a printer according to an exemplary embodiment of the present disclosure.

FIG. 2 is a view illustrating a data processing block of a central server 100 according to the exemplary embodiment.

FIG. 3 is a view illustrating a data processing block of an output device 200 according to the exemplary embodiment.

FIG. 4 is a signal flow diagram of the advertisement system of the printer according to the exemplary embodiment.

FIG. 5 is a flowchart illustrating in more detail a process of determining an advertisement exposure method in step S60 according to the exemplary embodiment.

### DETAILED DESCRIPTION

An advertisement system of a printer according to the exemplary embodiment includes: a central server configured to store detailed output device information including a type of an output device, an installation location, an advertisement output time, the number of times of advertisement output, and a rental fee, which are registered in the advertisement system of the printer, use the detailed output device information and registered user information so as to select an advertisement to be exposed to a user's computing device interworked with the output device, and control outputting of the advertisement; the output device configured to allow the advertisement to be exposed on a printout according to the output control of the central server; and the user's computing device configure to output the selected advertisement on a screen according to the control of the central server or the output device.

### Mode for Invention

Advantages and features of the present disclosure and the methods of achieving the same will become apparent with reference to exemplary embodiments described below in detail in conjunction with the accompanying drawings. However, the present disclosure is not limited to the exemplary embodiments disclosed below, but will be implemented in a variety of different forms. These exemplary embodiments are provided only to complete the disclosure of the present disclosure and to completely inform the scope of the present disclosure to those skilled in the art to which the present disclosure pertains, and the present disclosure is only defined by the scope of the claims. Like reference numerals generally denote like elements throughout the present disclosure.

In the following descriptions of the exemplary embodiments of the present disclosure, it is to be noted that, when a detailed description of a known function or configuration may unnecessarily obscure the subject matter of the present disclosure, the detailed description thereof will be omitted. In addition, terms to be described later are terms defined in consideration of functions in the exemplary embodiments of the present disclosure, which may vary according to the intention or custom of users or operators. Therefore, definitions of these terms should be made on the basis of the content throughout the present specification.

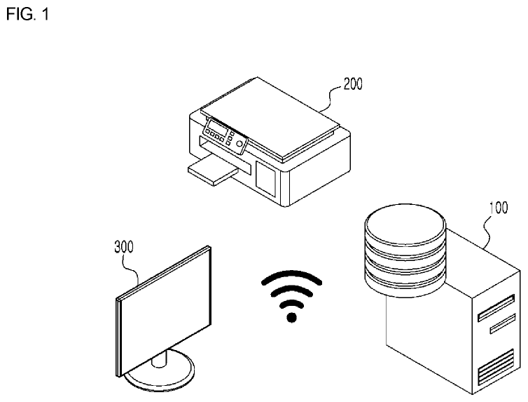

FIG. 1 is a view illustrating a configuration of an advertisement system of a printer according to the exemplary embodiment of the present disclosure.

Referring to FIG. 1, the advertisement system of the printer according to the exemplary embodiment may be configured to include a central server 100, an output device 200, and a computing device 300. The central server 100 stores detailed output device information including a type of an output device, an installation location, an advertisement output time, the number of times of advertisement output, and a rental fee, which are registered in the advertisement system of the printer, and controls advertisement output to the computing device interworked with the output device by using the detailed output device information. In addition, the central server 100 stores and updates user information such as an age of an individual user, a field of interest, and an area where the output device is used, which are registered in the advertisement system of the printer.

The output device 200 is the output equipment of a printer and the like, and when receiving a print request signal from the computing device 300 interworked with the output device, or receiving an advertisement output signal from the central server 100, the output device 200 outputs an advertisement to a printout or the computing device on the basis of the print request signal and the advertisement output signal.

The computing device 300 is equipment configured to generate and transmit output content while interworking with the output device 200, and includes a series of smart devices that includes a central control device such as a computer, a notebook computer, a smartphone, and a smartpad. The computing device 300 transmits a print request message to the output device 200 through wired/wireless communication.

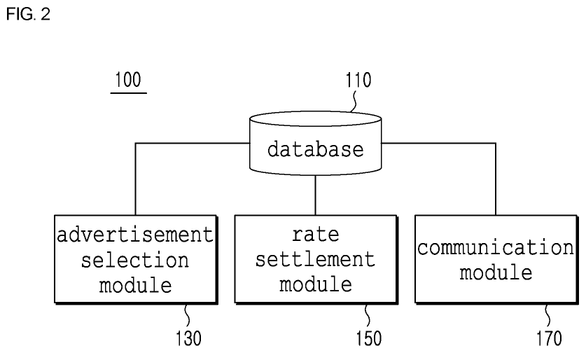

FIG. 2 is a view illustrating a data processing block of the central server 100 according to the exemplary embodiment.

Referring to FIG. 2, the central server 100 may be configured to include a database 110, an advertisement selection module 130, a rate settlement module 150, and a communication module 170. The term “module” used in this specification should be interpreted as being able to include software, hardware, or a combination thereof, depending on the context in which the term is used. For example, the software may be a machine language, a firmware, an embedded code, and an application software. As another example, the hardware may be a circuit, a processor, a computer, an integrated circuit, an integrated circuit core, a sensor, microelectromechanical systems (MEMS), a passive device, or a combination thereof.

The database 110 stores detailed information of each output device and each user who has subscribed to the advertisement system of the printer. For example, the database 110 may store each piece of information including: various information on each output device, such as a type of an output device, an installation location, a rental fee, device state information, and the like; personal information including a user's age, an address, a rental area, a phone number, and the like; and other information including main content of a printout; a field of interest; rental company information, and the like.

The advertisement selection module 130 is configured to select an optimal advertisement by analyzing the characteristics of a company or an individual who rented an output device, and output the selected advertisement to each computing device interworked with the rented output device. In the exemplary embodiment, in a case where an output device is installed in a university, the advertisement selection module 130 selects an advertisement where students are major consumers so that the advertisement is displayed on each computing device, or allows an advertisement to be displayed on each output device for an area adjacent to an area in which each output device is installed. The advertisement selection may be performed according to an analysis result after analyzing each location where the output device is installed, or analyzing ages, fields of interest, occupation groups, and the like of major users.

The rate settlement module 150 is configured to calculate both of the total time an advertisement is displayed on a computing device interworked with the rented output device and the number of times in which the advertisement is output on a printout, and according to the calculated results, settle an advertisement fee, or discount a rental fee for the output device. In the exemplary embodiment, the advertisement fee may be calculated as a reward such as points or cash in proportion to the number of advertisement exposures. In addition, in the exemplary embodiment, the rate settlement module 150 selects, as a major advertiser, an advertiser customer who pays an advertisement amount greater than or equal to a predetermined level among advertisers registered in the advertisement system, or the advertiser customer whose subscription period exceeds a predetermined period. Thereafter, when the major advertiser's advertisement is output, in a case where a print request signal is transmitted to an output device, advertisement content of the major advertiser is respectively displayed and printed on both the output device and a printout. That is, the advertising effectiveness may be increased by simultaneously exposing the advertisement on the computing device and the printout for the advertisement content requested by the major advertiser.

The communication module 170 is configured to manage an output device by collecting an output device state, advertisement exposure status, and the like, which are registered in the advertisement system of the printer, and transmit advertisement content selected for each output device to each output device. In addition, the central server 100 may store printer advertisement applications and programs, and the communication module 170 may transfer, in a distributed manner, the stored printer advertisement applications and programs to an output device and a smart terminal controlling the output device.

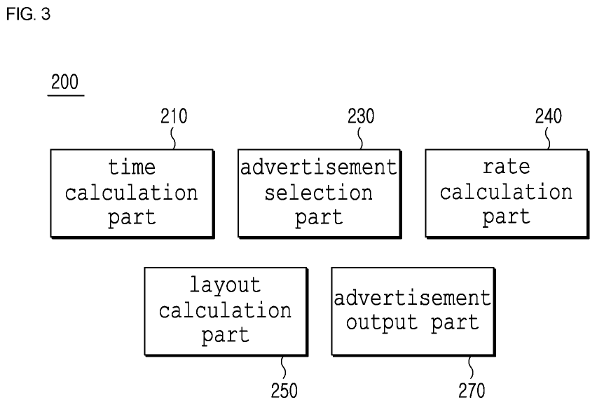

FIG. 3 is a view illustrating a data processing block of the output device 200 according to the exemplary embodiment.

Referring to FIG. 3, the output device 200 may be configured to include a time calculation part 210, an advertisement selection part 230, a rate calculation part 240, a layout calculation part 250, and an advertisement output part 270. The time calculation part 210 calculates the amount of time in which an advertisement is displayed on each computing device interworked with a respective output device and the number of times in which the advertisement is printed on a printout.

The advertisement selection part 230 selects advertisement content exposed to an output device or a printout according to an area where the output device is installed, main content of the printout, an age of a customer using the output device, a main field of interest, and the like. For example, when the customer using an output device is a white-collar office worker in his or her thirties, the advertisement selection part 230 selects the advertisement content by which the customer of the office-worker in his or her thirties may become a target consumer. In addition, the advertisement selection part 230 may analyze an area where the output device is installed, gender and an age of a customer, and main output content, so as to select an advertisement to be output on the basis of the analyzed results.

The rate calculation part 240 calculates a rental fee discount amount or a reward amount of an output device in proportion to a print waiting time for which an advertisement is output on a screen of a computing device and the number of pages of a printout printed with the advertisement. In addition, the rate calculation part 240 may raise and calculate an advertisement fee according to a size and a position of advertisement content that is printed on printing paper. For example, when the advertisement content is printed in the center of the printing paper, the fee calculation part 240 may raise and calculate the advertisement fee according to the number of printed pages of the printing paper.

When an advertisement to be output is selected, the layout calculation part 250 calculates a display layout or a print layout of the advertisement according to a print request message. In the exemplary embodiment, when the print request message is received from an output device 200, a print wait time is calculated, and when the print wait time exceeds a predetermined time or a user sets the advertisement to be displayed on a computing device, a layout in which the selected advertisement is displayed on the computing device 300 is calculated. Specifically, a display area of the computing device 300 is identified, and an advertisement output layout including the size and ratio of an advertisement object is calculated, so that advertisement content may be exposed on the display area of the output device for the predetermined time.

In addition, in the exemplary embodiment, when the print waiting time is less than the predetermined time or the user sets the advertisement to be output in a printout, the layout calculation part 250 sets an area into which the advertisement is to be inserted and calculates the advertisement output layout according to the size and layout of the printout included in the print request message. For example, the layout calculation part may determine the size, blank space, page number area, and the like of a sheet of paper, so as to extract an area in which the advertisement may be printed, and determine the size of the extracted area so as to set an advertisement layout.

In addition, in the exemplary embodiment, the layout calculation part 250 identifies information on a size, a blank space, a margin of a printout, and a size of an advertisement, which are included in a print request signal transmitted to an output device, so that the advertisement is printed in the margin of the printout. For example, the layout calculation part 250 calculates each blank space size of the top, bottom, and sides of the printout, and adjusts a size and an aspect ratio of advertisement content according to an aspect ratio of the blank space, so that the advertisement is printed on the printout without proportion distortion of the advertisement content. In addition, in the exemplary embodiment, the advertisement content may be output together with page numbers, or the advertisement content may be printed on a printout by inserting the advertisement content into page number design or upper and lower margin design. In addition, when the output content is all text, the layout calculation part 250 may output the advertisement content to the center of printing paper. In addition, when specific advertisement content is set to be printed as a background in the center of the printing paper, an aspect ratio and size of an advertisement image are adjusted according to the size and aspect ratio of the printing paper, so that the advertisement image is inserted inside the printing paper having a particular size thereof and inside the area where the content is printed on the printing paper. In the exemplary embodiment, when advertisement content is printed in the center of the printing paper, the saturation, sharpness, and transparency of the advertisement content are set less than or equal to a predetermined level of saturation and colors of output content, and the transparency is set to exceed a predetermined percentage of the output content, so as to ensure that a user is not only exposed to the advertisement content through the printing paper, but also has no inconvenience in reading the output content.

In addition, in the exemplary embodiment, when outputting an advertisement to a computing device during a print waiting time, the layout calculation part 250 adjusts a layout of advertisement content in consideration of a size and an aspect ratio of an output screen, so as to allow the advertisement to be output to the computing device without design distortion of the advertisement content.

In addition, in the exemplary embodiment, the layout calculation part 250 sets keywords according to advertisement types in advertisement content, and identifies the keywords of content to be printed. Thereafter, by comparing the keywords of the content output on a printout with the keywords according to the advertisement type, the advertisement content having a large number of keywords matching the keywords of the output content may be preferentially printed as the advertisement content in the printout.

In addition, in the exemplary embodiment, the layout calculation part 250 adjusts the size of the advertisement content according to the number of times in which the content keywords and the advertisement keywords, which are output on the printing paper match to each other, so as to allow the advertisement to be output on the printout. For example, the size of the advertisement content printed on the printout may be adjusted to increase in proportion to the number of times in which the keywords indicating the advertisement content and the keywords indicating output content match to each other.

In addition, when the number of pages of printout is greater than or equal to a preset number, or when a print waiting time exceeds a predetermined time, the layout calculation part 250 may adjust the size of the advertisement content to the minimum size thereof, or may adjust the advertisement content to be output only on odd-numbered pages or even-numbered pages, in order to reduce the print waiting time. In addition, in the exemplary embodiment, the layout calculation part 250 adjusts a layout and horizontal and vertical sizes of the advertisement content that is output to the printout so that the size of the printed advertisement content becomes smaller as the number of output sheets of paper increases, whereby, when printing a printout having the number of output sheets of paper or the amount of printing that exceeds a predetermined level, it is ensured that the printing time is not delayed due to the printing of the advertisement content.

The advertisement output part 270 outputs a selected advertisement according to the layout of a computing device or a printout. In the exemplary embodiment, when the advertisement is output on a printout, the advertisement is printed on the top or bottom margin and a page number area according to the layout of the printout.

Hereinafter, an advertisement method of an advertisement system of a printer according to the exemplary embodiment will be described in sequence. Since the operation (i.e., function) of the advertisement method according to the exemplary embodiment is essentially the same as the function on the advertisement system of the printer, a description overlapping with that in FIGS. 1 to 3 will be omitted.

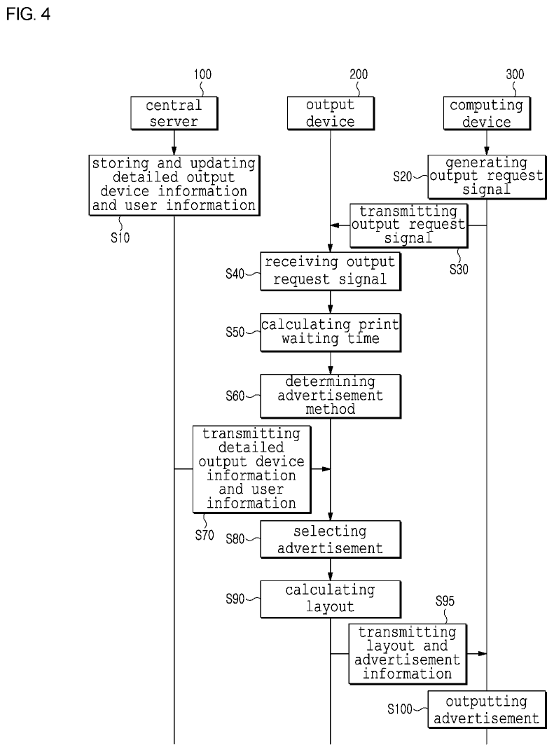

FIG. 4 is a signal flow diagram of the advertisement system of the printer according to the exemplary embodiment.

Referring to FIG. 4, in step S10, the central server 100 stores and updates user information and detailed output device information.

In step S20, an output request signal to be transmitted from a computing device to an output device is generated. In the exemplary embodiment, the output request signal, as a print request message, includes content to be printed, the size and the number of printing paper, layout information, and the like. In step S30, the output request signal is transmitted from the computing device 300 to the output device 200. The output device 200 receives the output request signal in step S40, and calculates a print waiting time in step S50 on the basis of content data and the number and size of prints, which are included in the output request signal.

In step S60, an advertisement method is determined, and in step S70, the detailed output device information and the user information are transmitted from the central server 100 to the output device 200. In step S80, an advertisement to be exposed through an output device or a printout is selected by using the user information and the detailed output device information received from the output device 200, and in step S90, a layout of the advertisement to be output is calculated. In step S95, the output device 200 transmits the layout and the information on the selected advertisement to the interconnected computing device 300. In step S100, the advertisement is output on a screen of the computing device, or is printed on a printout.

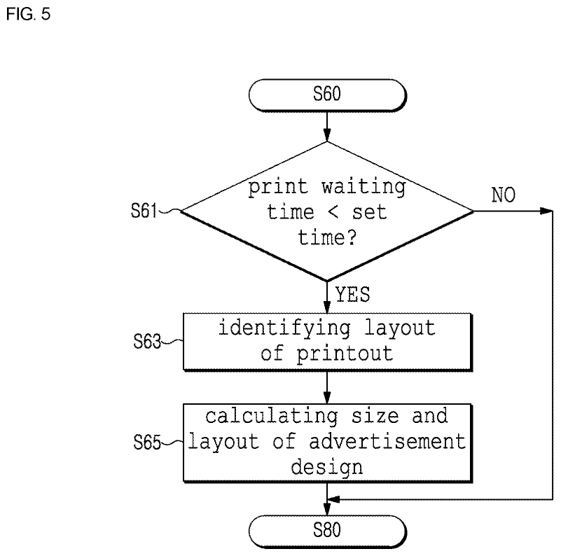

FIG. 5 is a flowchart illustrating in more detail a process of determining an advertisement exposure method in step S60 according to the exemplary embodiment.

Referring to FIG. 5, in step S60, a step of determining the advertisement method is entered. In order to determine the advertisement exposure method, in step S61, a print waiting time is calculated according to a print request signal, and the calculated print waiting time is compared with a set time. When the print waiting time is less than the set time, in step S63, a layout of a printout is determined in order to expose an advertisement by means of the printout. When the print waiting time exceeds the set time, an advertisement exposure time is secured for greater than or equal to a predetermined amount of time even though the advertisement is displayed on a computing device during the print waiting time, so a step S80 is entered, thereby selecting the advertisement to be displayed on an output device and calculating the layout corresponding to the selected advertisement.

In addition, in the exemplary embodiment, in step S63, the layout calculation part 250 identifies a size of an advertisement, and a size, a blank space, a margin of a printout included in a print request signal transmitted to an output device, so that the advertisement is printed in the margin of the printout. For example, a step S63 may include: calculating, by the layout calculation part 250, each blank space size of the top, bottom, and sides of a printout; adjusting a size and an aspect ratio of advertisement content according to an aspect ratio of each blank space; and printing the advertisement content, for which the size and proportion thereof is adjusted, on the printout without the proportion distortion. In addition, in the exemplary embodiment, advertisement content may be output together with page numbers, or the advertisement content may be printed on the printout by inserting the advertisement content into page number design or upper and lower margin design. In addition, in step S63, when output content is all text, the layout calculation part 250 may output the advertisement content to the center of printing paper. In addition, when specific advertisement content is set to be printed as a background in the center of the printing paper, the aspect ratio and the size of an advertisement image are adjusted according to the size and aspect ratio of the printing paper, so that the advertisement image is inserted inside the printing paper having the size thereof and inside the area where the content is printed on the printing paper. In addition, in the exemplary embodiment, when advertisement content is printed in the center of the printing paper, the saturation, sharpness, and transparency of the advertisement content is set less than or equal to a predetermined level of saturation and colors of output content, and the transparency is set to exceed a predetermined percentage of the output content, so as to ensure that a user is not only exposed to the advertisement content through the printing paper, but also has no inconvenience in reading the output content.

In addition, in step S63, the layout calculation part 250 sets keywords according to advertisement types in the advertisement content, and identifies the keywords of content to be printed. Thereafter, by comparing the keywords of the content output on a printout with the keywords according to the advertisement type, the advertisement content having a large number of keywords matching the keywords of the output content may be preferentially printed as the advertisement content in the printout.

In addition, in the exemplary embodiment, in step S63, the layout calculation part 250 adjusts the size of the advertisement content according to the number of times in which the content keywords and the advertisement keywords, which are output on printing paper match to each other, so as to allow the advertisement to be output on the printout. For example, the size of advertisement content printed on a printout may be adjusted to increase in proportion to the number of times in which keywords indicating the advertisement content and keywords indicating output content match to each other.

In addition, in step 63, when the number of pages of printout is greater than or equal to a preset number, or when a print waiting time exceeds a predetermined time, the layout calculation part 250 may adjust the size of advertisement content to the minimum size thereof, or may adjust the advertisement content to be output only on odd-numbered pages or even-numbered pages, in order reduce the print waiting time. In addition, in the exemplary embodiment, the layout calculation part 250 adjusts a layout and horizontal and vertical sizes of advertisement content output to a printout so that the size of the printed advertisement content becomes smaller as the number of output sheets of paper increases, whereby, when printing the printout having the number of output sheets of paper or the amount of printing that exceeds a predetermined level, it is ensured that the printing time is not delayed due to the printing of the advertisement content.

In addition, in the exemplary embodiment, when a user desires to increase the advertisement exposure in the advertisement system of the printer, the selected advertisement may be displayed on the computing device during the print waiting time, and at the same time, the advertisement content may be printed on the printout. In addition, when the user sets the advertisement to be output on the printout, the advertisement may be printed on the printout regardless of the print waiting time.

The advertisement system of the printer as described above outputs a customized advertisement selected according to a customer on a screen of a computing device during a print waiting time that inevitably occurs when using a printer, so as to calculate an advertisement fee and a reward, thereby enabling both the user who rented the printer and the rental company to generate additional revenue. In addition, an advertisement is exposed during the print waiting time that inevitably occurs during operation of prints, whereby the advertising effectiveness may be improved. In addition, when the calculated print waiting time is less than a predetermined time, the advertisement content is allowed to be printed on the printout, so that the advertising effectiveness may be generated even with the short print waiting time.

The disclosed subject matter is only an example, and without departing from the gist of the claims claimed in the claims, various modifications may be made by those skilled in the art, so the scope of protection of the disclosed subject matter is not limited to the specific exemplary embodiment described above in detail.

### INDUSTRIAL APPLICABILITY

The advertisement system of the printer as described above calculates an advertisement fee and a reward by respectively displaying or outputting an advertisement with a computing device or a printout during a print waiting time that inevitably occurs when using a printer, thereby enabling both a rental company and a user who rented the printer to generate additional revenue, and enabling the rental company to increase advertising effectiveness by exposing the advertisement during the print waiting time that inevitably occurs. In addition, when the calculated print waiting time is less than a predetermined time, advertisement content is allowed to be printed on the printout, so that the advertising effectiveness may be generated even with a short print waiting time.

1. An advertisement system of a printer, the system comprising:
a central server configured to store detailed output device information including a type of an output device, an installation location, an advertisement output time, the number of times of advertisement output, and a rental fee, which are registered in the advertisement system, select an advertisement to be output to a user's computing device interworked with the output device by using the detailed output device information and registered user information, and control the advertisement output;
the output device configured to print the advertisement on a printout according to the control of the advertisement output of the central server; and
the user's computing device configured to output the selected advertisement on a screen according to the control of the central server or the output device.

2. The system of claim 1, wherein the central server comprises:
a database configured to store and update manager information, the detailed output device information including the type of the output device including the printer, a device state, an installation area, the advertisement output time, the number of times of the advertisement output, a contract period, the rental fee, and an advertisement reward, and customer information including an age, gender, and an occupation of a user who uses the output device;
an advertisement selection module configured to select the advertisement, according to an output location of the output device and the customer information, to be displayed on the output device or to be inserted into the printout printed from the output device;
a rate settlement module configured to calculate the advertisement reward or a rental fee discount rate of the output device on the basis of an amount of time and the number of times the selected advertisement is output to the output device, and the number of times the selected advertisement is printed on the printout; and
a communication module configured to communicate with the output device, and output the selected advertisement to the output device or output advertisement content on the printout, when a print request signal and a print start signal are received from the output device.

3. The system of claim 1, wherein the output device comprises:
a time calculation part configured to calculate a print waiting time according to an output request signal when receiving the output request signal or an output start signal from the computing device interworked with the output device;
an advertisement selection part configured to select the advertisement to be displayed on the user's computing device interworked with the output device according to the calculated print waiting time and the detailed output device information, and the user information on who has transmitted the output request signal;
a layout calculation part configured to calculate detailed advertisement print information including a size, design, and a layout of the advertisement content according to a size, the number of pages, and a layout of the printout when the selected advertisement is printed on the printout, and calculate a size, an aspect ratio, and a layout of an advertisement object according to a size of a display area and an aspect ratio of the computing device when the advertisement is displayed on the computing device; and
an advertisement output part configured to respectively output the advertisement, which is selected according to the user information, the print waiting time, and a type, the number of the pages, and the size of the printout, to the computing device and the printout.

4. The system of claim 3, wherein the output device further comprises:
a rate calculation part configured to calculate a rental fee discount amount or a reward amount of the output device in proportion to the print waiting time for which the advertisement is output and the number of pages of the printout on which the advertisement is printed.

5. The system of claim 2, wherein the rate settlement module is configured to select an advertiser customer, as a major advertiser, who pays an advertisement amount greater than or equal to a predetermined amount among advertisers registered in the advertisement system or whose registration period exceeds a predetermined period, and print and display the advertisement content requested by the major advertiser on each of the printout and the computing device, in a case where the print request signal is transmitted to the output device when outputting the advertisement of the major advertiser.

6. An advertisement method of an advertisement system of a printer, the method comprising:
step (A) of storing and updating, in a central server, detailed output device information including a type of an output device, an installation location, an advertisement output time, the number of times of advertisement output, and a rental fee, information on a user subscribing to the system, and information on a customer using the output device;
step (B) of receiving, in the output device, an output request signal from a computing device interworked with the output device;
step (C) of selecting, in the output device, an advertisement to be output to the output device or a printout according to personal information of the user of the computing device transmitting the output request signal, output information, an area where the output device is installed, and a printing waiting time;
step (D) of displaying the advertisement selected in a print waiting time of the printout to the computing device when the advertisement is displayed on the output device;
step (E) of calculating a size and a layout of an advertisement image to be printed according to the number of pages, a size, a layout, and design of the printout when the advertisement is printed on the printout of the output device; and
step (F) of outputting the advertisement image on printing paper according to the calculated size and layout of the advertisement image.

7. The method of claim 6, further comprising:
step (G) of calculating a reward and a rental fee discount rate of the output device according to an amount of time and the number of times wherein the advertisement is displayed on the computing device interworked with the output device, and the number of times wherein the advertisement is printed on the printout

8. The method of claim 6, wherein, in step (C), advertisement content to be displayed on the computing device or the printout is selected according to interest information of the user of the computing device interworked with the output device, or
the advertisement content is selected according to a location and place where the output device is installed.

9. The method of claim 6, wherein, in step (D), when the print waiting time exceeds a predetermined time, or when the user chooses to display the advertisement on the computing device, the selected advertisement content is displayed on the computing device.

10. The method of claim 6, in step (E), when the number of pages of the printout exceeds a predetermined number, or when the print waiting time is less than a predetermined time, or when the advertisement is set to be printed on the printout by the user, the advertisement is printed on the printout of the output device.

11. The method of claim 6, wherein step (D) comprises:
calculating, in the output device, the print waiting time by using the output request signal received from the computing device.
